(19) United States
(12) Patent Application Publication
(10) Pub. No.: US 2005/0014590 A1
(43) Pub. Date: Jan. 20, 2005

(54) Sprocket for a bicycle

(76) Inventor: Yi-Ling Wen, Fengyuan City (TW)

Correspondence Address: VENABLE, BAETJER, HOWARD AND CIVILETTI, LLP, P.O. BOX 34385, WASHINGTON, DC, 20043-9998, US

(21) Appl. No.: 10/702,588

(22) Filed: Nov. 7, 2003

(30) Foreign Application Priority Data
Jul. 17, 2003 (TW) 092216685

(51) Int. Cl. F16H 55/30; F16H 7/06

(52) U.S. Cl. 474/152; 474/160; 474/156

(57) ABSTRACT

A chain sprocket for a bicycle has a body and at least one cover. The body has a periphery, two side surfaces, multiple teeth formed on the periphery and the cover formed on the side surfaces of the body. The cover has at least one arcuate piece with an arcuate periphery for supporting a chain mounted on the chain sprocket. With such feature, the chain will not easily release from the sprocket whereby trouble-free transmission is provided.

### BACKGROUND OF THE INVENTION

1. Field of the Invention

The present invention relates to a sprocket, and more particularly to a sprocket for a bicycle, which can provide support to the chain and prevent the chain from escaping the sprocket.

2. Description of Related Art

A bicycle has a chain drive to drive the rear wheel when a rider rides the bicycle. With reference to FIGS. 6 and 7, the chain drive includes a front sprocket (40) and a chain (30). The chain (30) is reeved around the sprocket (40) and has multiple link plate pairs (not numbered) and multiple connectors (32). The link plate pairs and the connectors (32) are pivoted with each other in turn. Each link plate pair and each connector (32) have two arcuate edges (321), respectively.

The sprocket (40) is a disc and has a body (41) with a periphery (not numbered), and multiple teeth (42). The teeth (42) are formed at the periphery of the body (41) and each tooth (42) has a top (44) and a bottom (43). The bottom (43) is integrally formed at the periphery of the body (41) and the top (44) is aligned with the bottom (43) away from the body (41). When the chain (30) is mounted on the conventional sprocket (40), the tops (44) of the teeth (42) are inserted into the on the sprocket (40). One of the arcuate side edges (321) of the link plate pair and the connector (32) are suspended and beside the bottom (43) of the teeth (42). However, when the bicycle is ridden, the arcuate side edges (321) of the link plate pairs and the connectors (32) are not supported easily whereby the chain slips from the sprocket (40), causing considerable inconvenience and possible danger to the rider.

The present invention provides a sprocket for a bicycle to mitigate or obviate the aforementioned problems.

### SUMMARY OF THE INVENTION

The primary objective of the present invention is to provide a sprocket for a bicycle, wherein the sprocket has a body and at least one cover. The body has a periphery, two side surfaces, multiple teeth formed on the periphery and the cover is mounted on the side surfaces of the body. The cover has at least one arcuate piece with an arcuate periphery for supporting a chain mounted on the sprocket. With such feature, the chain mounted on the sprocket will not easily slip from the sprocket so that a bicycle fitted with the sprocket can provide trouble free transmission of power from the rider to the bicycle rear wheel.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a sprocket for a bicycle in accordance with the present invention;

FIG. 2 is a partial perspective view of the sprocket in FIG. 1 when a chain is mounted on the sprocket;

FIG. 3 is a partial exploded perspective view of the sprocket in FIG. 2;

FIG. 4 is a partial plan view in partial section of the sprocket along line 4-4 in FIG. 2;

FIG. 5 is a partial perspective view in partial section of a second embodiment of the sprocket in accordance with the present invention;

FIG. 6 is plan view of a conventional chain driver in accordance with the prior art; and

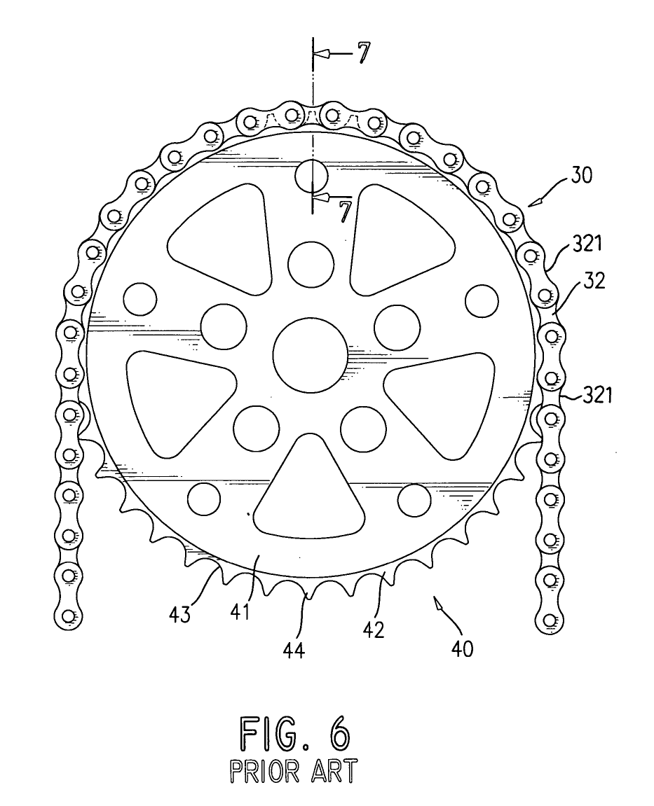

FIG. 7 is a partial plan view in section of the conventional chain driver in FIG. 6.

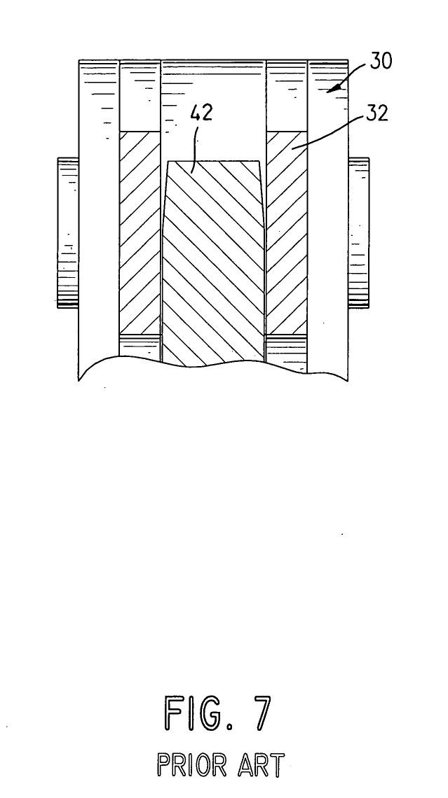

### DETAILED DESCRIPTION OF THE PREFERRED EMBODIMENT

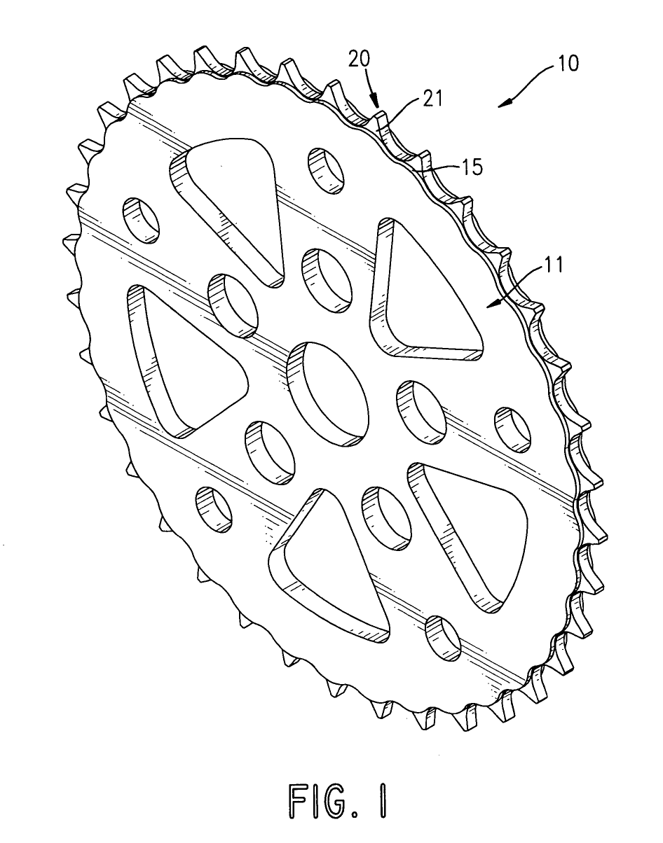

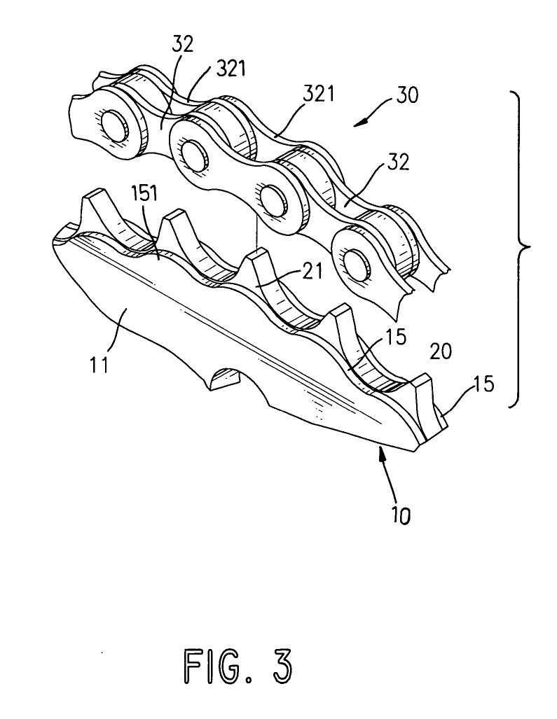

With reference to FIGS. 1 and 3, a sprocket (10) of a chain driver in accordance with the present invention has a body (not numbered) with a periphery (not numbered) and two side surfaces (not numbered), multiple teeth (20) and two covers (11) comprising a first cover and a second cover. The teeth (20) are formed at the periphery at the body and each tooth has a bottom (21). The teeth (20) are conventional so further description of the features and the operations are not included despite the differences.

Each cover (11) is integrally formed on one of the side surfaces of the body and has a periphery (not numbered) and multiple arcuate pieces (151). Each cover (11) is co-axial with the body and the diameter of the cover (11) is slightly smaller than the body so that the periphery of each cover (11) is slightly beneath the bottom (21) of the teeth (20). Each arcuate piece (151) has an arcuate periphery (15). The arcuate pieces (151) are integrally formed on the periphery of the cover (11) and extended from the periphery toward the top of the corresponding one of the teeth (20).

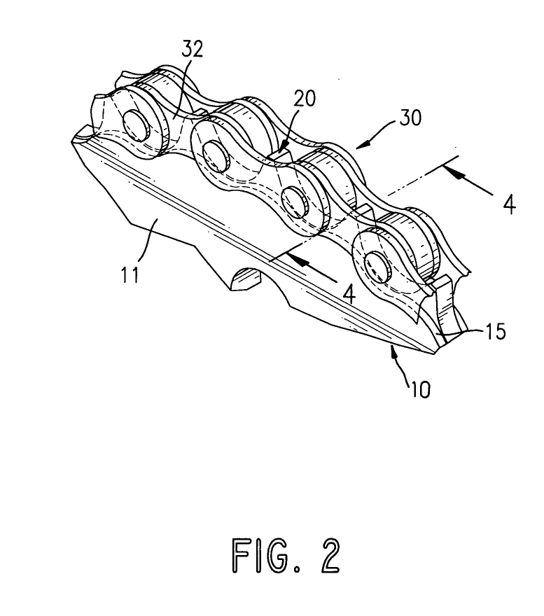

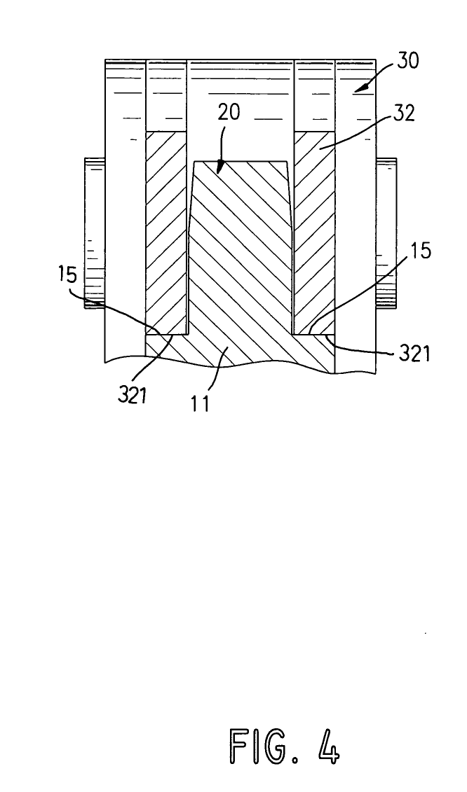

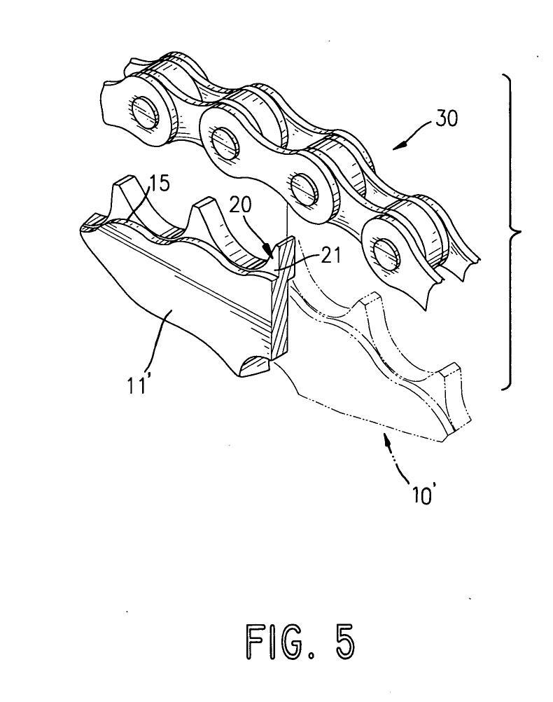

With reference to FIGS. 2 to 4, when the chain (30) is mounted on the sprocket (10), some of the teeth (20) are inserted into the link plate pairs or the connectors (32). One of the arcuate side edges of each link plate pair and each connector (32) are abutted to the arcuate peripheries (15) of the arcuate pieces (151). The sprocket (10) with two covers (11) will provide a support to the chain (30) and prevent the chain (30) slipping from the sprocket (10). With further reference to FIG. 5, the cover (11′) can be formed on one side surface of the chain roller (10′).

The sprocket (10,10′) in accordance with the present invention can provide an additional support to the chain (30), and make a bicycle fitted with the sprocket (10,10′) convenient to ride.

Even though numerous characteristics and advantages of the present invention have been set forth in the foregoing description, together with details of the structure and function of the invention, that the disclosure is illustrative only, and changes may be made in detail, especially in matters of shape, size, and arrangement of parts within the principles of the invention to the full extent indicated by the broad general meaning of the terms in which the appended claims are expressed is to be understood.

1. A sprocket for a bicycle having a chain, the chain having multiple link plate pairs and connectors alternately pivoted with each other, each link plate pair and each connector respectively having two arcuate side edges, and the sprocket comprising
a body having
a periphery,
two side surfaces, and
multiple teeth formed at the periphery of the body and each tooth having a bottom, and
a first cover integrally formed on one of the side surfaces of the body and having
a periphery, and
at least one arcuate piece formed at and extended out the periphery of the first cover, each arcuate piece having an arcuate periphery adapted for supporting the arcuate side edges of the link plate pairs and the connectors.

2. The sprocket for a bicycle as claimed in claim 1 further comprising a second cover integrally formed on the other side surface of the body and having
a periphery, and
at least one arcuate piece formed at and extended out the periphery of the second cover, each arcuate piece having an arcuate periphery adapted for supporting the arcuate side edges of the link plate pairs and the connectors.

3. The sprocket for a bicycle as claimed in claim 2, wherein multiple arcuate pieces are integrally formed at the periphery of each cover and each arcuate piece located with the arcuate side edge beside the bottom of one of the teeth.
